(19) United States
(12) Patent Application Publication
(10) Pub. No.: US 2002/0104223 A1
(43) Pub. Date: Aug. 8, 2002

(54) Razor with a movable cartridge

(75) Inventor: Brian Oldroyd, Reading (GB)

Correspondence Address: WILLIAM E. BOOTH, Fish & Richardson P.C., 225 Franklin Street, Boston, MA, 02110-2804, US

(73) Assignee: The Gillette Company, a Delaware corporation

(21) Appl. No.: 10/057,720

(22) Filed: Jan. 24, 2002

Related U.S. Application Data
(63) Continuation of application No. 08/742,280, filed on Oct. 31, 1996, now Pat. No. 6,381,857.
Application No. 08/742,280 is a continuation of application No. 08/313,055, filed on May 8, 1995, now abandoned.
Application No. 08/313,055 is a 371 of international application No. PCT/US93/03439, filed on Apr. 12, 1993.

(30) Foreign Application Priority Data
Apr. 13, 1992 (GB) 9208098.5

(51) Int. Cl. B26B 21/52

(52) U.S. Cl. 30/532; 30/527

(57) ABSTRACT

Mechanism for connecting a shaving cartridge to a razor handle with bearings to allow the cartridge to swivel about a first axis parallel to the edge of the cartridge blades and the bearings being supported on a linkage to permit the cartridge to rock end-to-end about a second axis perpendicular to the first swiveling axis and parallel to the direction of shaving.

This invention relates to a cartridge razor which includes a handle and a cartridge carrier mounted to the handle in a way which allows the cartridge to rotate relative to the handle about an axis which is perpendicular to the edge of the or each blade of the cartridge and parallel to the surface to be shaved, thereby to accommodate changing contours of a surface to be shaved.

Twin-blade cartridges which swivel about an axis parallel to the blade edges axe well-known. Such swivelling improves contact between the blades and the surface being shaved, and it has been found that the swivelling about the orthogonal axis improves blade contact, end to end. See GB-A-2116470 and GB-A-2172236.

Although the razor of GB-A-2116470 provides improved conformance with facial contours, end to end of the shaving cartridge, there is scope for further improvement and it is one object of the present invention to achieve such an improvement. What is required is a way of mounting the cartridge to the handle which allows the cartridge to move smoothly and with a minimum of friction about the axis perpendicular to the blade edge or edges, whenever there is a change of the angle between the handle and the surface being shaved. Further, the mounting should be compact enough not to interfere unduly with the user's vision of the area being shaved, or with subsequent rinsing of the cartridge.

A cartridge razor of the type initially defined above, and in accordance with the present invention, is characterized in that the rotation perpendicular to the edge of the or each blade of the cartridge is about an axis of rotation which lies either on or below the said surface to be shaved.

By so locating the rotation centre, it is possible to establish a stable reaction to changing contours of the surface being shaved, which ensures that the end to end rocking movements of the cartridge do not involve any motion in the line of the blade edges relative to that surface.

Conventional swivelling movement parallel to the edge of the or each blade of the cartridge can be provided between a cartridge carrier and the cartridge. Preferably, the axis of rotation of the cartridge parallel to the blade edge(s) is also on or below the surface to be shaved. When the two orthogonal rotational axes intersect, the combination of the two swivel axes creates and effective universal joint on or below the surface being shaved.

The cartridge carrier can itself be carried on a four-bar linkage which lies in a plane parallel to the blade edges. A suitable four-bar linkage has first and second transverse links, each with a mid-point pivotally mounted to the handle, and two opposite ends each pivotally mounted to an extension link, itself mounted pivotally to the end of the cartridge carrier, so that each end of the carrier is supported by one of the extension links of the four-bar linkages.

Conveniently, each of the four-bar transverse links is a bell crank having an apex at its mid-point and cranked left hand and right hand limbs extending in opposite directions from the apex but subtending an angle of less than 180°, for example, 60°, so that the bell crank points, like an arrow head, towards the cartridge carrier. This is one effective way to move the centre of rotation of the carrier away from its mounting in the handle and towards the desired position on or behind the surface to be shaved.

A four-bar linkage as described immediately above has already been disclosed, see GB 1460732, but only as a pair of such linkages, to provide swivel motion about the axis parallel to the blade edges. The rotational axis is above the surface to be shaved.

Preferably, a biasing spring is provided, to urge the carrier to a start disposition so that during shaving whenever the cartridge is no longer subject to forces tending to rotate it about the rotational axis perpendicular to the blade edges, the biasing means will urge the carrier back to its start disposition. A preferred biasing spring is a resilient wishbone mounted at its apex to the said bell crank and with its limbs pressing against the two extension links.

For a better understanding of the invention, and to show more clearly how the same may be carried into effect, reference will now be made, by way of example, to the accompanying drawings, in which:

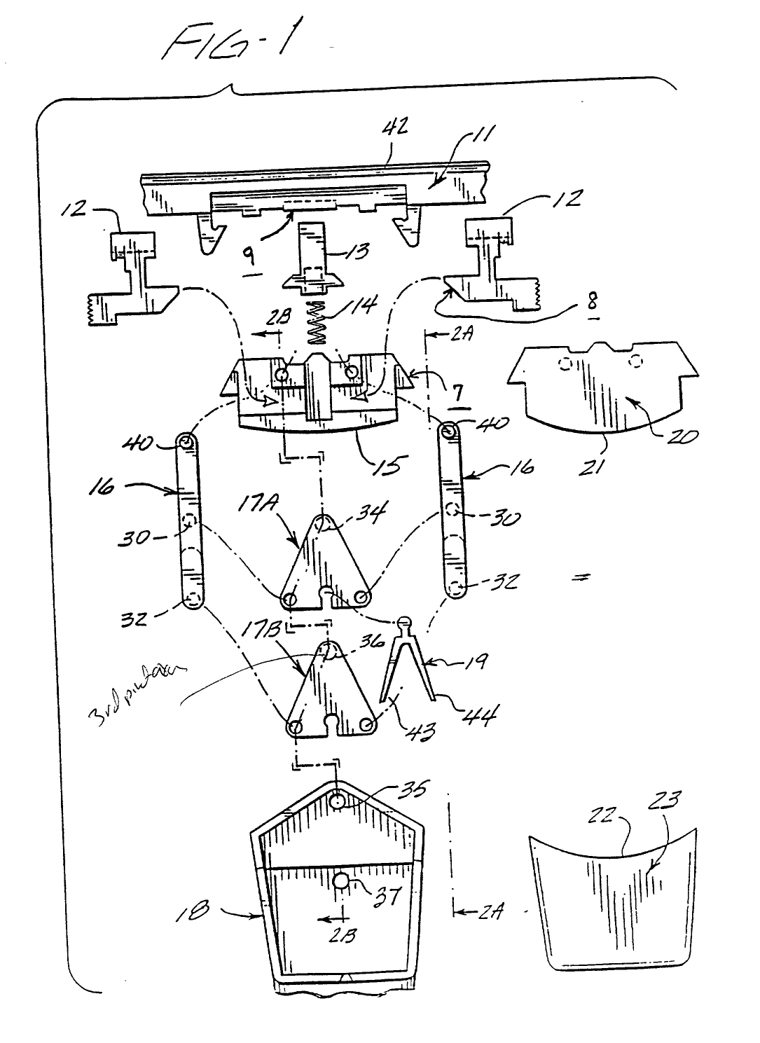

FIG. 1 is a first elevation, exploded, to show various individual components of a preferred embodiment of razor in accordance with the invention;

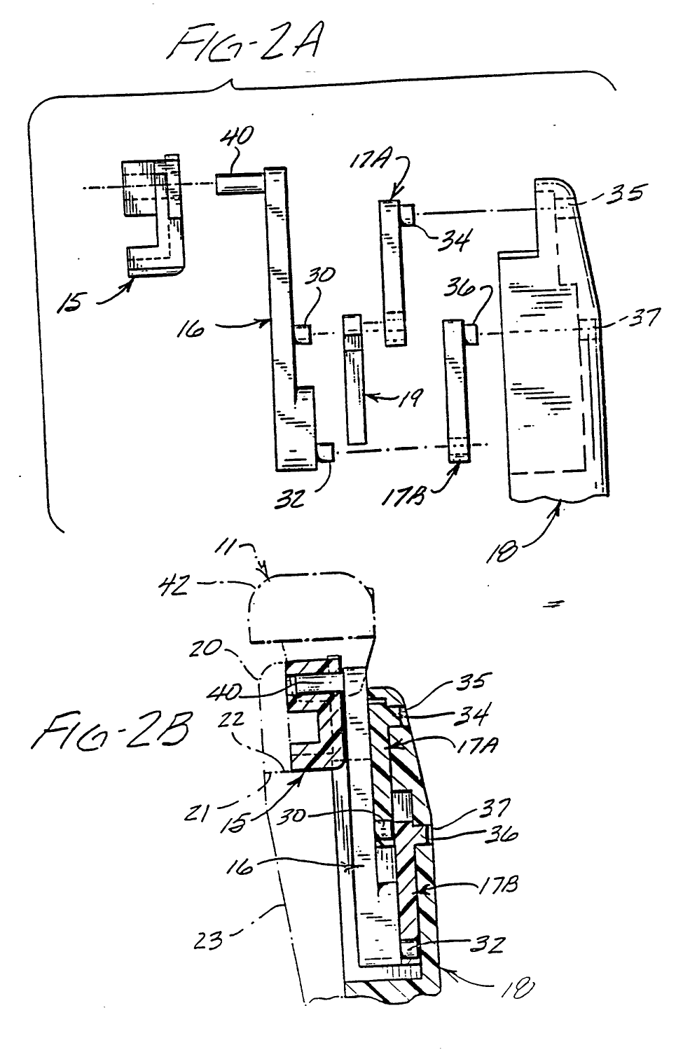

FIG. 2A is an exploded side view of a portion of the linkage as seen along view line 2A-2A of FIG. 1;

FIG. 2B is a longitudinal cross sectional view as taken along line 2B-2B of FIG. 1, the parts being shown in their assembled position;

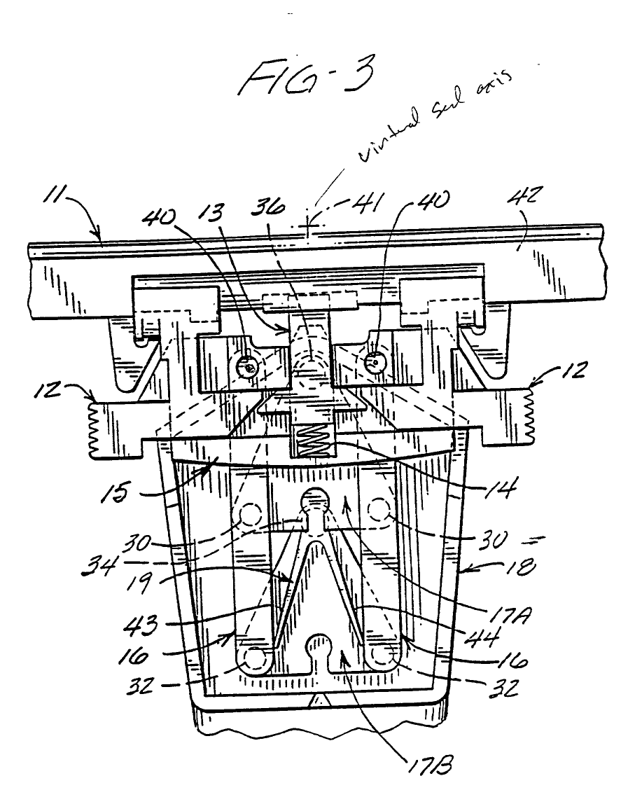

FIG. 3 is a front elevational view of the assembled razor with the cover plates removed;

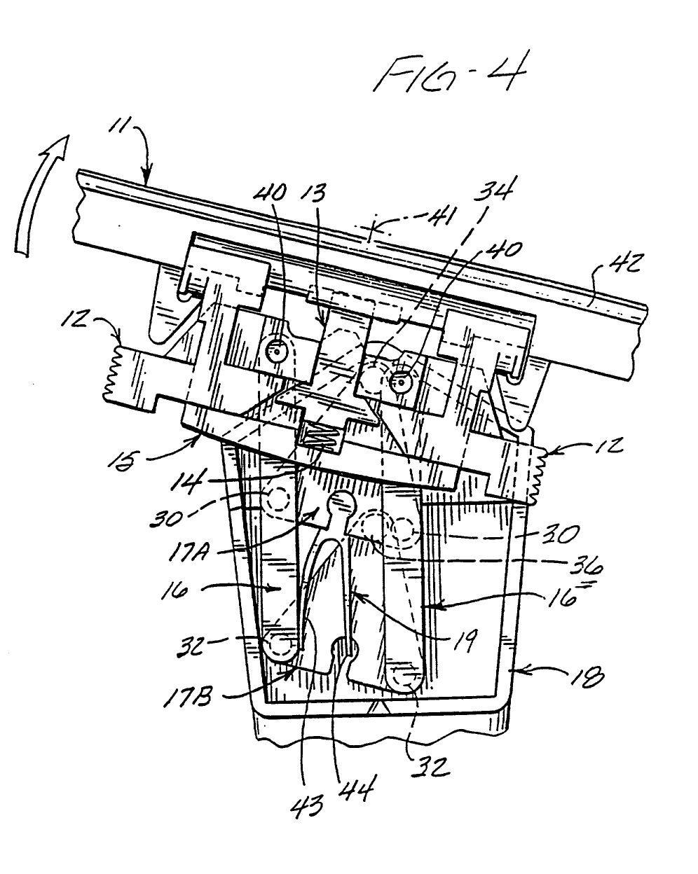

FIG. 4 is a front elevational view similar to FIG. 3 with the razor shown in a tilted position;

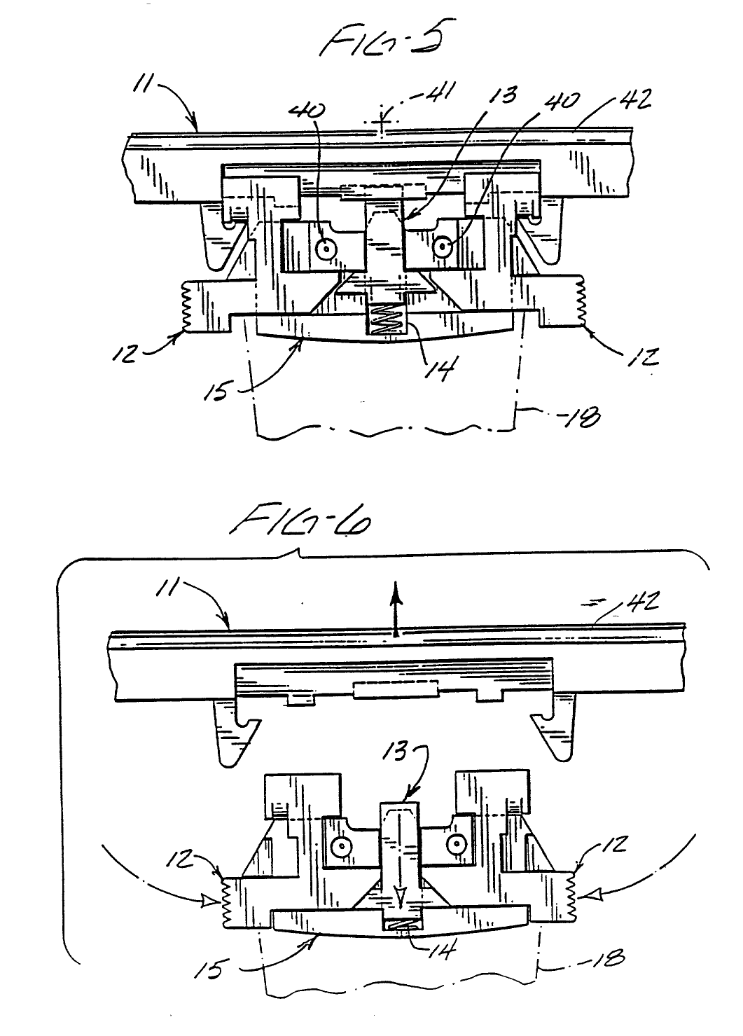

FIG. 5 is a fragmentary elevational view showing the cartridge being retained by the carrier; and,

FIG. 6 is a view similar to FIG. 5 showing the cartridge released from the carrier.

Referring to FIG. 1, a shaving cartridge 11 is held by a pair of shell bearings 12, in a manner known per se, to the remainder of the razor system. A plunger 13 is mounted in the razor for endwise movement and a compression spring 14 acts on the plunger to urge it into endwise pressure on a ramp surface 9 on the cartridge, thereby to urge the cartridge into a centered median disposition in the shell bearings 12, as is known per se. To change the cartridge the shell bearings are squeezed together. Not only does this release the bearings but it also causes ramp surfaces 7, 8 to depress the plunger 13 against the action of the spring 14, to release the cartridge 11 from the razor, This also is known per se.

A cartridge carrier 15 carries the shell bearings 12 and plunger 13. The carrier is itself mounted on a four-bar linkage parallel with the blade edges. The linkage comprises a pair of extension links 16, one on each side of each of a pair of bell cranks 17A, 17B. These cranks are themselves pivotally mounted to a planar area 18 of the razor handle. A resilient wishbone spring 19 is clipped on to the upper bell crank 17A so that its two legs press against the extension links 16 to centre the linkage. A plate 20 covers the carrier 15 and has an arcuate edge 21 which abuts a corresponding edge 22 on a cover plate 23 for the handle area 18. The arcs of the edges 21, 22 are centered on the centre of rotation of the cartridge carrier 15 so that, when the carrier 15 rocks to follow facial contours, there is relative movement between the edges 21 and 22. In the preferred embodiment this relative motion can be sliding movement.

Referring now to FIG. 2A and 2B, the four-bar linkage is shown from the side so that only one of the extension links 16 is visible. Each such link 16 has an upper boss 30 to engage with the upper bell crank 17A and a lower boss 32 to engage with the lower crank 17B. At the apex of the upper crank 17A is a boss 34 which is carried in a bore 35 in the handle 18. At the apex of the lower crank 17B is a boss 36 which is carried in a bore 37.

Referring now to FIG. 3, each extension link 16 is pivotally connected to the cartridge carrier 15 by a boss 40. The carrier 15 rocks about these two bosses 40 in a locus which corresponds to a centre of rotation 41 which is determined by the geometry of the bell cranks 17A and 17B. It can be seen that the centre of rotation 41 is on the opposite side of the shaving surface 42 of the cartridge from the razor handle, that is, below the surface to be shaved.

Referring now to FIG. 4, a 15° tilt about the centre of rotation 41 has the effect of pressing the left hand leg 43 of the wishbone 19 against the left hand link 16 and the resultant elastic deformation of the leg produces a force tending to restore the four-bar linkage to a central disposition. The other leg 44 provides the restoring force when the rotation is in the other direction. With rotation as shown in FIG. 4, the leg 44 simply moves out of contact with its adjacent extension link 16.

FIGS. 5 and 6 show how the cartridge is mounted and separated from the remainder of the razor. As is mentioned above, the construction and operation is in itself already known, as from the SENSOR (trademark) razor, sold by the present Applicant.

1. A cartridge razor which includes a handle (18) and a cartridge carrier (15) mounted to the handle in a way which allows the cartridge mounted on the carrier to rotate relative to the handle, about an axis which is perpendicular to the edge of the or each blade of the cartridge and parallel to the surface to be shaved, with changing contours of a surface to be shaved and characterized in that said rotation is about a centre of rotation (41) which lies either on or below the said surface to be shaved.

2. A razor as claimed in claim 1, wherein the cartridge carrier is itself carried on a four-bar linkage (16, 17) which lies in a plane parallel to the blade edges.

3. A razor as claimed in claim 2, wherein the four-bar linkage includes first and second transverse links (17), each with a mid-point pivotally mounted to the handle, and two opposite ends each pivotally mounted to an=extension link (16) itself pivotally mounted to one end of the cartridge carrier.

4. A razor as claimed in claim 3, wherein the transverse links are bell cranks.

5. A razor as claimed in claim 1, wherein the cartridge is provided with a cover surface (20) which moves with the carrier relative to the handle, the cover surface having an arcuate edge (21) which abuts a corresponding edge portion (22) of a surface (23) of the handle, for relative sliding movement between the said edges when the carrier moves relative to the handle.

6. A razor as claimed in claim 1, including biasing means (19) to urge the carrier to rotate to a start disposition as soon as the carrier is no longer subject to any shaving forces tending to displace the carrier from said start disposition.
